(19) United States
(12) Patent Application Publication
(10) Pub. No.: US 2020/0324400 A1
(43) Pub. Date: Oct. 15, 2020

(54) ADJUSTABLE MECHANIC APPARATUS

(71) Applicant: Stephen Mcmanimie, Spanaway, WA (US)

(72) Inventor: Stephen Mcmanimie, Spanaway, WA (US)

(21) Appl. No.: 16/382,396

(22) Filed: Apr. 12, 2019

(51) Int. Cl. B25H 5/00; E04G 1/22; E04G 1/28

(52) U.S. Cl. CPC B25H 5/00; E04G 2001/242; E04G 1/28; E04G 1/22

(57) ABSTRACT

An adjustable mechanic apparatus to facilitate elevated access to a vehicle, including a bottom frame portion to allow a user to stand thereupon, the bottom portion including a bottom central planar surface to be disposed near a front portion or a rear portion of the vehicle, the bottom central planar surface having a length that is longer than a width of the vehicle, and such that the bottom central planar surface is disposed substantially perpendicularly with respect to a length of the vehicle, a first bottom planar support surface disposed perpendicularly away from a first end of the bottom central planar surface with respect to a first lateral direction, a second bottom planar support surface disposed perpendicularly away from a second end of the bottom central planar surface with respect to the first lateral direction, and a plurality of adjustable legs removably connected to at least a portion of at least one of a bottom portion of the bottom central planar surface, a bottom portion of the first bottom planar support surface, and a bottom portion of the second bottom planar support frame to allow the bottom surface portion to be elevated above a ground surface, and a top frame portion to extend perpendicularly away from a top surface of the bottom frame portion in a second direction to create a wall-like structure that prevents the user from falling onto the vehicle.

### BACKGROUND

### 1. Field

The present general inventive concept relates generally to an apparatus, and particularly, to an adjustable mechanic apparatus.

### 2. Description of the Related Art

For some vehicles, an engine may be difficult to access for a vehicle mechanic and/or a vehicle enthusiast. For example, a truck or a sport utility vehicle (“SUV”) may be elevated a distance above a ground surface that makes it difficult to reach the engine of a vehicle.

Moreover, the car mechanic and/or the car enthusiast risk receiving injuries while leaning over the engine. Tools may be placed on the ground and/or on a nearby surface, which can make working on the engine of the vehicle tedious. Additionally, a bumper of the vehicle can be damaged if the car mechanic and/or the car enthusiast steps on the bumper and/or drops the automotive tools on the bumper.

Therefore, there is a need for an adjustable mechanic apparatus that facilitates access to the engine of the vehicle.

### SUMMARY

The present general inventive concept provides an adjustable mechanic apparatus.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an adjustable mechanic apparatus to facilitate elevated access to a vehicle, including a bottom frame portion to allow a user to stand thereupon, the bottom portion including a bottom central planar surface to be disposed near a front portion or a rear portion of the vehicle, the bottom central planar surface having a length that is longer than a width of the vehicle, and such that the bottom central planar surface is disposed substantially perpendicularly with respect to a length of the vehicle, a first bottom planar support surface disposed perpendicularly away from a first end of the bottom central planar surface with respect to a first lateral direction, a second bottom planar support surface disposed perpendicularly away from a second end of the bottom central planar surface with respect to the first lateral direction, and a plurality of adjustable legs removably connected to at least a portion of at least one of a bottom portion of the bottom central planar surface, a bottom portion of the first bottom planar support surface, and a bottom portion of the second bottom planar support frame to allow the bottom surface portion to be elevated above a ground surface, and a top frame portion to extend perpendicularly away from a top surface of the bottom frame portion in a second direction to create a wall-like structure that prevents the user from falling onto the vehicle.

The bottom central planar surface may include a slit transversely disposed at a center of the bottom central planar surface, a first portion disposed on a first side of the slit, and a second portion disposed on a second side of the slit.

At least one of the first portion and the second portion may move from retracted at the slit in a first lateral position to at least partially extended away from the slit in a second lateral position.

The top frame portion may include an adjustable width motor disposed within at least a portion of the top frame portion to adjust a length of the bottom portion or a length of the top portion, such that at least a portion of the bottom portion or at least a portion of the top portion move in response to a rotation of the adjustable width motor.

At least one of the first bottom planar support surface and the second bottom planar support surface, may move from folded toward the bottom central planar surface in a first pivoting position to at least partially opened in a second pivoting position.

At least one of the first bottom planar support surface may move from retracted at the first end of the bottom central planar surface to at least partially extended away from the first end of the bottom central planar surface, and the second bottom planar support surface moves from retracted at the second end of the bottom central planar surface to at least partially extended away from the second end of the bottom central planar surface.

Each of the plurality of adjustable legs may move from at least partially retracted in a first vertical position to at least partially extended in a second vertical position.

Each of the plurality of adjustable legs may include an adjustable leg height motor disposed within at least a portion of each of the plurality of adjustable legs to adjust a height thereof, such that each of the plurality of adjustable legs moves in response to a rotation of the adjustable leg height motor.

The top frame portion may be disposed along an edge of the bottom frame portion nearest to the vehicle.

The top frame portion may include a top central planar surface to be disposed near the front portion or the rear portion of the vehicle, the bottom central planar surface having a length that is longer than a width of the vehicle, and such that the bottom central planar surface is disposed substantially perpendicularly with respect to a length of the vehicle, a first top planar support surface disposed perpendicularly away from a first end of the top central planar surface with respect to the first lateral direction, and a second top planar support surface disposed perpendicularly away from a second end of the top central planar surface with respect to the first lateral direction.

The top central planar surface may include a slit transversely disposed at a center of the top central planar surface, a first portion disposed on a first side of the slit, and a second portion disposed on a second side of the slit.

At least one of the first portion and the second portion may move from retracted at the slit in a first lateral position to at least partially extended away from the slit in a second lateral position.

The first top planar support surface may simultaneously move in response to movement of the first bottom planar support surface, and the second top planar support surface simultaneously moves in response to movement of the second bottom planar support surface.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top isometric view of an adjustable mechanic apparatus, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Adjustable Mechanic Apparatus 100
Top Frame Portion 110
Top Central Planar Surface 111
First Surface 111a
Second Surface 111b
Slit 111c
First Top Planar Support Surface 112
First Surface 112a
Second Surface 112b
Second Top Planar Support Surface 113
First Surface 113a
Second Surface 113b
Plurality of Adjustable Width Buttons 114
Adjustable Width Motor 115
Bottom Frame Portion 120
Bottom Central Planar Surface 121
First Surface 121a
Second Surface 121b
Slit 121c
First Bottom Planar Support Surface 122
First Surface 122a
Second Surface 122b
Second Bottom Planar Support Surface 123
First Surface 123a
Second Surface 123b
Plurality of Adjustable Leg Height Buttons 124
Plurality of Adjustable Legs 125
Adjustable Leg Height Motor 125a
Wheel 125b
Plurality of Adjustable Beams 130
At Least One Tool Tray 140
Ladder 150

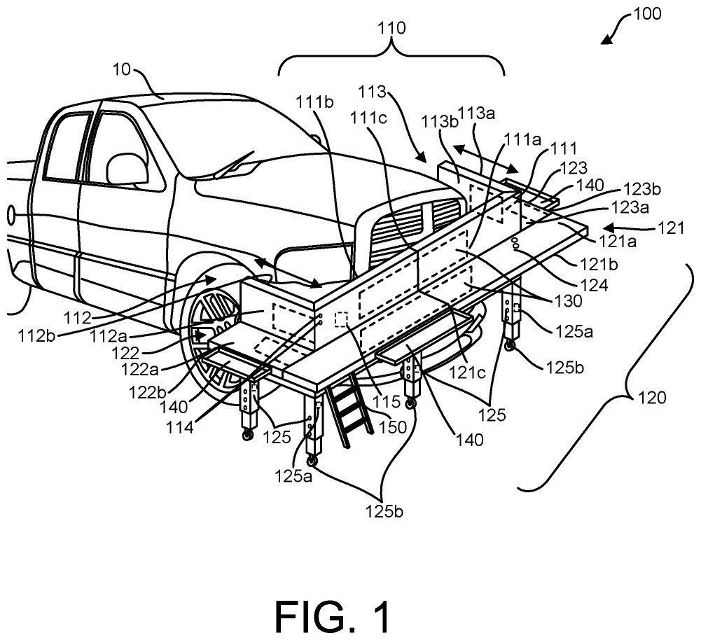

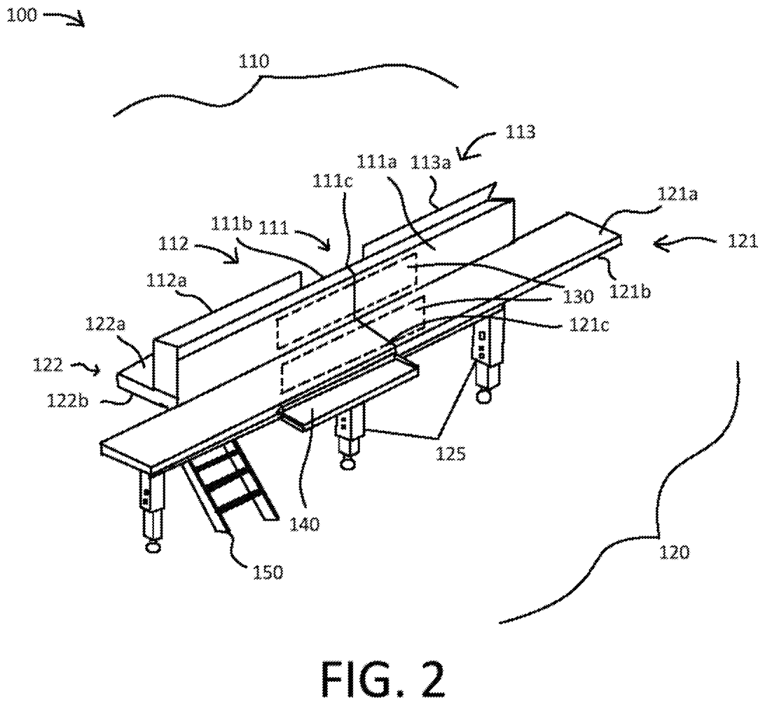

FIG. 1 illustrates a top isometric view of an adjustable mechanic apparatus 100, according to an exemplary embodiment of the present general inventive concept.

The adjustable mechanic apparatus 100 may be constructed from at least one of metal, plastic, wood, glass, and rubber, etc., but is not limited thereto.

The adjustable mechanic apparatus 100 may include a top frame portion 110, a bottom frame portion 120, a plurality of adjustable beams 130, at least one tool tray 140, and a ladder 150, but is not limited thereto.

The top frame portion 110 may include a top central planar surface 111, a first top planar support surface 112, a second top planar support surface 113, a plurality of adjustable width buttons 114, and an adjustable width motor 115, but is not limited thereto.

The top central planar surface 111 may include a first surface 111a, a second surface 111b, and a slit 111c, but is not limited thereto.

The first top planar support surface 112 may include a first surface 112a and a second surface 112b, but is not limited thereto.

The second top planar support surface 113 may include a first surface 113a and a second surface 113b, but is not limited thereto.

The top central planar surface 111 may be of any predetermined length to extend a length greater than a width of a vehicle 10. The first top planar support surface 112 may be perpendicularly disposed at a first end of the top central planar surface 111. The second top planar support surface 113 may be perpendicularly disposed at a second end of the top central planar surface 111. Additionally, a length of the first top planar support surface 112 may be equivalent to a length of the second top planar support surface 113, such that the first top planar support surface 112 and the second top planar support surface 113 may extend a length along each side of the vehicle 10. As such, the first top planar support surface 112 and the second top planar support surface 113 may surround at least a portion of each side of the vehicle 10.

The first surface 111a and the second surface 111b of the top central planar surface 111 may have a padding material disposed on at least a portion thereof. The padding material may include a foam or a gel, but is not limited thereto. The padding material may reduce a force and/or an object that contacts at least a portion of the top central planar surface 111.

The first surface 112a and the second surface 112b of the first top planar support surface 112 may have the padding material disposed on at least a portion thereof. The padding material may reduce a force and/or an object that contacts at least a portion of the first top planar support surface 112.

The first surface 113a and the second surface 113b of the second top planar support surface 113 may have the padding material disposed on at least a portion thereof. The padding material may reduce a force and/or an object that contacts at least a portion of the second top planar support surface 113.

The bottom frame portion 120 may include a bottom central planar surface 121, a first bottom planar support surface 122, a second bottom planar support surface 123, a plurality of adjustable leg height buttons 124, and a plurality of adjustable legs 125, but is not limited thereto.

The bottom central planar surface 121 may include a first surface 121a, a second surface 121b, and a slit 121c, but is not limited thereto.

The first bottom planar support surface 122 may include a first surface 122a and a second surface 122b, but is not limited thereto.

The second bottom planar support surface 123 may include a first surface 123a and a second surface 123b, but is not limited thereto.

The bottom central planar surface 121 may be of the predetermined length to extend a length greater than the width of the vehicle 10. The first bottom planar support surface 122 may be perpendicularly disposed at a first end of the bottom central planar surface 121. The second bottom planar support surface 123 may be perpendicularly disposed at a second end of the bottom central planar surface 121. Additionally, a length of the first bottom planar support surface 122 may be equivalent to a length of the second bottom planar support surface 123, such that the first bottom planar support surface 122 and the second bottom planar support surface 123 may surround at least a portion of each side of the vehicle 10.

The bottom central planar surface 121, the first bottom planar support surface 122, and/or the second bottom planar support surface 123 may support at least a portion of a body of the user thereupon. Moreover, the bottom central planar surface 121, the first bottom planar support surface 122, and/or the second bottom planar support surface 123 may support any object placed thereupon.

The top frame portion 110 may extend perpendicularly away from a top surface of the bottom frame portion 120 in a second direction to create a wall-like structure that prevents the user from falling onto the vehicle 10. As such, the first top planar support surface 112 may extend perpendicularly away from a top surface of the first bottom planar support surface 122 at an edge portion thereof. The second top planar support surface 113 may extend perpendicularly away from a top surface of the second bottom planar support surface 123 at an edge portion thereof.

The first surface 121a and the second surface 121b of the bottom central planar surface 121 may have the padding material disposed on at least a portion thereof. The padding material may reduce a force and/or an object that contacts at least a portion of the bottom central planar surface 121.

The first surface 122a and the second surface 112b of the first bottom planar support surface 122 may have the padding material disposed on at least a portion thereof. The padding material may reduce a force and/or an object that contacts at least a portion of the first bottom planar support surface 122.

The first surface 123a and the second surface 123b of the second bottom planar support surface 123 may have the padding material disposed on at least a portion thereof. The padding material may reduce a force and/or an object that contacts at least a portion of the second bottom planar support surface 123.

Furthermore, the first top planar support surface 112 and the first bottom planar support surface 122 may pivot in a first pivoting direction or a second pivoting direction from a first pivoting position (i.e. folded) to a second pivoting position (i.e. opened), such that the first top planar support surface 112 and the first bottom planar support surface 122 may move at least partially away from the top central planar surface 111 and the bottom central planar surface 121, respectively. Alternatively, the first top planar support surface 112 and the first bottom planar support surface 122 may pivot in the second pivoting direction or the first pivoting direction from the second pivoting position to the first pivoting position, such that the first top planar support surface 112 and the first bottom planar support surface 122 may move at least partially toward the top central planar surface 111 and the bottom central planar surface 121, respectively.

Furthermore, the second top planar support surface 113 and the second bottom planar support surface 123 may pivot in the first pivoting direction or the second pivoting direction from the first pivoting position (i.e. folded) to the second pivoting position (i.e. opened), such that the second top planar support surface 113 and the second bottom planar support surface 123 may move at least partially away from the top central planar surface 111 and the bottom central planar surface 121, respectively. Alternatively, the second top planar support surface 113 and the second bottom planar support surface 123 may pivot in the second pivoting direction or the first pivoting direction from the second pivoting position to the first pivoting position, such that the second top planar support surface 113 and the second bottom planar support surface 123 may move at least partially toward the top central planar surface 111 and the bottom central planar surface 121, respectively.

Therefore, the first top planar support surface 112 and the first bottom planar support surface 122 may be folded to store the adjustable mechanic apparatus 100 and increase portability. Similarly, the second top planar support surface 113 and the second bottom planar support surface 123 may be folded to store the adjustable mechanic apparatus 100 and increase portability.

Each of the plurality of adjustable legs 125 may include an adjustable leg height motor 125a and a wheel 125b, but is not limited thereto. However, the wheel 125b may be removably connected to each of the plurality of adjustable legs 125. As such, each of the plurality of legs 125 may resist movement of the adjustable mechanic apparatus 100 in response to removal of the wheel 125b.

Each of the plurality of adjustable legs 125 may be constructed to use a pneumatic cylinder and/or a hydraulic cylinder.

The plurality of adjustable legs 125 may be removably connected to at least a portion of the second surface 121b of the bottom central planar surface 121, the second surface 122b of the first bottom planar support surface 122, and/or the second surface 123b of the second bottom planar support surface 123, but is not limited thereto. As such, removal of the plurality of adjustable legs 125 may increase portability of the adjustable mechanic apparatus 100. Moreover, the plurality of adjustable legs 125 may support the bottom frame portion 120 and the top frame portion 110.

At least one of the plurality of adjustable width buttons 114 may be depressed to adjust a length of at least one of the top central planar surface 111, the first top planar support surface 112, and the second top planar support surface 113. Moreover, the bottom central planar surface 121, the first bottom planar support surface 122, and the second bottom planar support surface 123 may adjust in response to movement corresponding to each aforementioned respective vertical frame. In other words, the bottom central planar surface 121 may adjust in response to movement of the top central planar surface 111, the first bottom planar support surface 122 may adjust in response to movement of the first top planar support surface 112, and the second bottom planar support surface 123 may adjust in response to movement of the second top planar support surface 113. Alternatively, the plurality of adjustable width buttons 114 may be depressed to adjust the length of at least one of the bottom central planar surface 121, the first bottom planar support surface 122, and the second bottom planar support surface 123.

The slit 111c of the top central planar surface 111 may be transversely disposed at a center of the top central planar surface 111.

Specifically, the adjustable width motor 115 may rotate in response to the at least one of the plurality of adjustable width buttons 114 being depressed. More specifically, a first portion of the top central planar surface 111 on a first side of the slit 111c may move in a first lateral direction or a second lateral direction from a first position (i.e. retracted) to a second position (i.e. extended), and a second portion of the top central planar surface 111 on a second side of the slit 111c may move in the second lateral direction or the first lateral direction, such that the first portion of the top central planar surface 111 on the first side of the slit 111c and the second portion of the top central planar surface 111 on the second side of the slit 111c move at least partially away from each other in response to the rotation of the adjustable width motor 115. Alternatively, another at least one of the plurality of adjustable width buttons 114 may be depressed to at least partially move the first portion of the top central planar surface 111 on the first side of the slit 111c and the second portion of the top central planar surface 111 on the second side of the slit 111c toward each other in response to the rotation of the adjustable width motor 115.

The slit 121c of the bottom central planar surface 121 may be transversely disposed at a center of the bottom central planar surface 121.

A first portion of the bottom central planar surface 121 on a first side of the slit 121c and a second portion of the bottom central planar surface 121 on a second side of the slit 121c may move similarly to the top central planar surface 111, as described above.

At least one of the plurality of adjustable beams 130 may be disposed within at least a portion of the top central planar surface 111. Another at least one of the plurality of adjustable beams 130 may be disposed within at least a portion of the bottom central planar surface 121. Moreover, each of the plurality of adjustable beams 130 may be at least partially exposed in response to movement of the top central planar surface 111 and the bottom central planar surface 121. As such, the length of the top central planar surface 111 and the bottom central planar surface 121 may be extended.

The first top planar support surface 112 may move in a third lateral direction or a fourth lateral direction from a first side position (i.e. retracted) to a second side position (i.e. extended) at least partially away from the first end of the top central planar surface 111. Alternatively, the first top planar support surface 112 may move in the fourth lateral direction or the third lateral direction from the second side position to the first side position at least partially toward the first end of the top central planar surface 111.

The first bottom planar support surface 122 may move similarly to the first top planar support surface 112, as described above.

The second top planar support surface 113 may move in the third lateral direction or the fourth lateral direction from the first side position to the second side position at least partially away from the second end of the top central planar surface 111. Alternatively, the second top planar support surface 113 may move in the fourth lateral direction or the third lateral direction from the second side position to the first side position at least partially toward the second end of the top central planar surface 111.

The second bottom planar support surface 123 may move similarly to the second top planar support surface 113, as described above.

Also, another at least one of the plurality of adjustable beams 130 may be disposed within at least a portion of the first top planar support surface 112 and the second top planar support surface 113. Also, another at least one of the plurality of adjustable beams 130 may be disposed within at least a portion of the first bottom planar support surface 122 and the second bottom planar support surface 123. Moreover, each of the plurality of adjustable beams 130 may be at least partially exposed in response to movement of the first top planar support surface 112 and the first bottom planar support surface 122. Also, each of the plurality of adjustable beams 130 may be at least partially exposed in response to movement of the second top planar support surface 113 and the second bottom planar support surface 123. As such, the length of the first top planar support surface 112, the first bottom planar support surface 122, the second top planar support surface 113, and the second bottom planar support surface 123 may be extended.

Furthermore, each wheel 125b of the plurality of adjustable legs 125 may roll in response to movement of the first top planar support surface 112, the first bottom planar support surface 122, the second top planar support surface 113, and/or the second bottom planar support surface 123. Each wheel 125b may include a locking mechanism, such as a brake and/or a clamp to prevent each wheel 125b from movement. Moreover, each wheel 125b may be constructed to be a caster, but is not limited thereto. As such, the user may lock each wheel of the plurality of adjustable legs 125 during use of the adjustable mechanic apparatus 100 to prevent movement thereof.

At least one of the plurality of leg height buttons 124 may be depressed to adjust a height of each of the plurality of adjustable legs 125. Specifically, the adjustable leg height motor 125a may rotate in response to the at least one of the plurality of adjustable leg height buttons 124 being depressed. Each of the plurality of adjustable legs 125 may move in a first vertical direction or a second vertical direction from a first position (i.e. retracted) to a second position (i.e. extended) at least partially away from a ground surface in response to the rotation of the adjustable leg height motor 125a. Alternatively, another at least one of the plurality of adjustable leg height buttons 124 may be depressed, such that the plurality of adjustable legs 125 may move in the second vertical direction or the first vertical direction from the second position to the first position at least partially toward the ground surface in response to the rotation of the adjustable leg height motor 125a.

At least one tool tray 140 may be removably connected to at least a portion of the top frame portion 110 and/or the bottom frame portion 120, but is not limited thereto. The at least one tool tray 140 may store an item therein. For example, the at least one tool tray 140 may store at least one tool therein to facilitate access to the at least one tool.

The ladder 150 may be removably connected to at least a portion of the bottom frame portion 120. For example, at least a portion of a first end of the ladder 150 may be placed on the ground surface, such that the ladder 150 may stand thereupon. Also, at least a portion of a second end of the ladder 150 may be removably connected to at least a portion of the bottom frame portion 120, such that the ladder 150 may lean against the bottom portion. As such, the ladder 150 may receive the user thereon.

Therefore, the adjustable mechanic apparatus 100 may facilitate elevated access to the vehicle 10. Furthermore, the adjustable mechanic apparatus 100 may adjust in length to accommodate different sizes of vehicles. Additionally, the adjustable mechanic apparatus 100 may fold on at least a portion thereof to increase portability and improve storage by reducing required space.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An adjustable mechanic apparatus to facilitate elevated access to a vehicle, comprising:
a bottom frame portion to allow a user to stand thereupon, the bottom portion comprising:
a bottom central planar surface,
a first bottom planar support surface disposed perpendicularly away from a first end of the bottom central planar surface with respect to a first lateral direction,
a second bottom planar support surface disposed perpendicularly away from a second end of the bottom central planar surface with respect to the first lateral direction, and
a plurality of adjustable legs removably connected to at least a portion of at least one of a bottom portion of the bottom central planar surface, a bottom portion of the first bottom planar support surface, and a bottom portion of the second bottom planar support frame to allow the bottom frame portion to be elevated above a ground surface, the plurality of adjustable legs comprising:
a first leg removably connected to a first side of a center of the bottom central planar surface,
a second leg removably connected to a second side of the center of the bottom central planar surface, and
a third leg removably connected to the second side of the center of the bottom central planar surface, such that a first distance from the first leg to the second leg is greater than a second distance from the second leg to the third leg, such that the first leg, the second leg, and the third leg have a space therebetween; and
a top frame portion to extend perpendicularly away from a top surface of the bottom frame portion in a second direction to create a wall that prevents the user from falling.

2. The adjustable mechanic apparatus of claim 1, wherein the bottom central planar surface comprises:
a slit transversely disposed at a center of the bottom central planar surface;
a first portion disposed on a first side of the slit; and
a second portion disposed on a second side of the slit.

3. The adjustable mechanic apparatus of claim 2, wherein at least one of the first portion and the second portion, move from retracted at the slit in a first lateral position to at least partially extended away from the slit in a second lateral position.

4. The adjustable mechanic apparatus of claim 3, wherein the top frame portion comprises:
an adjustable width motor disposed within at least a portion of the top frame portion to adjust a length of the bottom portion or a length of the top portion, such that at least a portion of the bottom portion or at least a portion of the top portion move in response to a rotation of the adjustable width motor.

5. The adjustable mechanic apparatus of claim 1, wherein at least one of the first bottom planar support surface and the second bottom planar support surface, move from folded toward the bottom central planar surface in a first pivoting position to at least partially opened in a second pivoting position.

6. The adjustable mechanic apparatus of claim 1, wherein at least one of the first bottom planar support surface moves from retracted at the first end of the bottom central planar surface to at least partially extended away from the first end of the bottom central planar surface, and the second bottom planar support surface moves from retracted at the second end of the bottom central planar surface to at least partially extended away from the second end of the bottom central planar surface.

7. The adjustable mechanic apparatus of claim 1, wherein each of the plurality of adjustable legs moves from at least partially retracted in a first vertical position to at least partially extended in a second vertical position.

8. The adjustable mechanic apparatus of claim 7, wherein each of the plurality of adjustable legs comprises:
an adjustable leg height motor disposed within at least a portion of each of the plurality of adjustable legs to adjust a height thereof, such that each of the plurality of adjustable legs moves in response to a rotation of the adjustable leg height motor.

9. The adjustable mechanic apparatus of claim 1, wherein the top frame portion is disposed along an edge of the bottom frame portion.

10. The adjustable mechanic apparatus of claim 1, wherein the top frame portion comprises:
a top central planar surface;
a first top planar support surface disposed perpendicularly away from a first end of the top central planar surface with respect to the first lateral direction; and
a second top planar support surface disposed perpendicularly away from a second end of the top central planar surface with respect to the first lateral direction.

11. The adjustable mechanic apparatus of claim 10, wherein the top central planar surface comprises:
a slit transversely disposed at a center of the top central planar surface;
a first portion disposed on a first side of the slit; and
a second portion disposed on a second side of the slit.

12. The adjustable mechanic apparatus of claim 11, wherein at least one of the first portion and the second portion, move from retracted at the slit in a first lateral position to at least partially extended away from the slit in a second lateral position.

13. The adjustable mechanic apparatus of claim 10, wherein the first top planar support surface simultaneously moves in response to movement of the first bottom planar support surface, and the second top planar support surface simultaneously moves in response to movement of the second bottom planar support surface.
